(19) United States
(12) Patent Application Publication
(10) Pub. No.: US 2021/0194170 A1
(43) Pub. Date: Jun. 24, 2021

(54) CONNECTION LOCK

(71) Applicant: LINTEX CO., LTD., Zhanghua County (TW)

(72) Inventor: CHIA-SHENG LIN, ZHANGHUA COUNTY (TW)

(21) Appl. No.: 17/123,657

(22) Filed: Dec. 16, 2020

(30) Foreign Application Priority Data
Dec. 24, 2019 (TW) 108217172

(51) Int. Cl. H01R 13/426; H01R 13/639

(52) U.S. Cl. CPC H01R 13/426; H01R 13/60; H01R 13/6397

(57) ABSTRACT

A connection lock is provided, including: a driving member, movable between first and second positions; a locking device by which the driving member is restrictable in the second position; a first housing; an actuating assembly, movably mounted to the first housing and assembled with the driving member; a blocking assembly, mounted to the first housing and movable between release and blocking positions; an electronic transmission unit, connected to the first housing; when the driving member is in the first position, the actuating assembly is driven by the driving member to drive the blocking assembly to the release position, the blocking assembly is detachable from an anti-theft hole; when the driving member is in the second position, the driving member drives the actuating assembly and the actuating assembly restricts the blocking assembly in the blocking position so that the blocking assembly is undetachable from the anti-theft hole.

### BACKGROUND OF THE INVENTION

### Field of the Invention

The present invention relates to a connection lock.

### Description of the Prior Art

In recent years, the living quality is improving, and people lead a fast-paced life, so people have great demand for getting information instantly. Portable 3C (computer, communication, consumer electronics) products like laptops becomes important in everyday life and workplace. However, 3C products can be easily stolen because they are valuable, light and portable. To prevent 3C products from being stolen, a burglarproof locking device for 3C products is provided. The burglarproof locking device includes a locking member for being inserted and locked within an anti-theft hole of a 3C product.

However, in recent years, 3C products have highly developed, while the conventional anti-theft lock for 3C products is merely provided with burglarproof function without any additional functions. As a result, it has not been able to meet the needs in the market.

The present invention is, therefore, arisen to obviate or at least mitigate the above-mentioned disadvantages.

### SUMMARY OF THE INVENTION

The main object of the present invention is to provide a connection lock which is burglarproof and capable of being integral with an electronic transmission unit for adaption of 3C products.

To achieve the above and other objects, a connection lock is provided, including: a driving member, movable between a first position and a second position; a locking device by which the driving member is restrictable in the second position; a first housing; an actuating assembly, movably mounted to the first housing and assembled with the driving member; a blocking assembly, mounted to the first housing and movable between a release position and a blocking position, configured to be inserted within an anti-theft hole of a 3C product; an electronic transmission unit, connected to the first housing, configured to be inserted within a transmission port of the 3C product; wherein when the driving member is located in the first position, the actuating assembly is driven by the driving member and the blocking assembly is movable to be in the release position, the blocking assembly is detachable from the anti-theft hole; when the driving member is located in the second position, the driving member drives the actuating assembly and the actuating assembly restricts the blocking assembly to be positioned in the blocking position so that the blocking assembly is undetachable from the anti-theft hole.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram of a preferable embodiment of the present invention;

FIG. 2 is a breakdown drawing of a preferable embodiment of the present invention;

FIG. 3 is a stereogram of a driving member according to a preferable embodiment of the present invention;

FIGS. 4 and 5 are front views showing operation of a preferable embodiment of the present invention;

FIGS. 6 and 7 are cross-sectional side views showing operation of a preferable embodiment of the present invention;

FIG. 8 is a stereogram of another preferable embodiment of the present invention;

FIG. 9 is a breakdown drawing of the another preferable embodiment of the present invention;

FIG. 10 is a stereogram of a blocking member according to the another preferable embodiment of the present invention;

FIG. 11 is a front view showing operation of the another preferable embodiment of the present invention;

FIG. 12 is an enlargement of FIG. 11;

FIG. 13 is a partial stereogram of the another preferable embodiment of the present invention;

FIG. 14 is a front view showing operation of the another preferable embodiment of the present invention;

FIG. 15 is an enlargement of FIG. 11; and

FIG. 16 is a partial stereogram showing operation of the another preferable embodiment of the present invention.

### DETAILED DESCRIPTION OF THE PREFERRED EMBODIMENTS

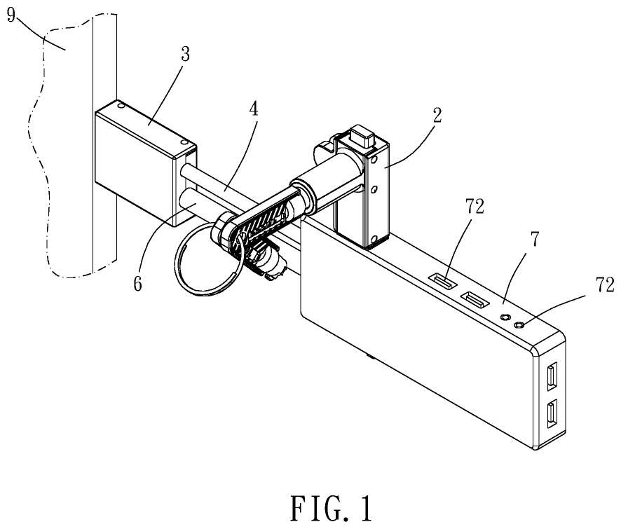

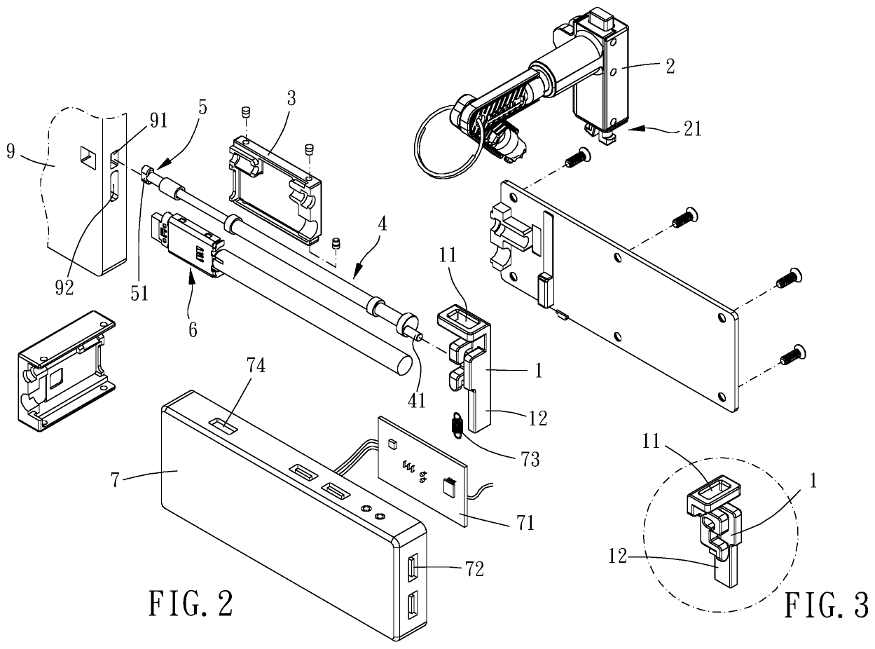

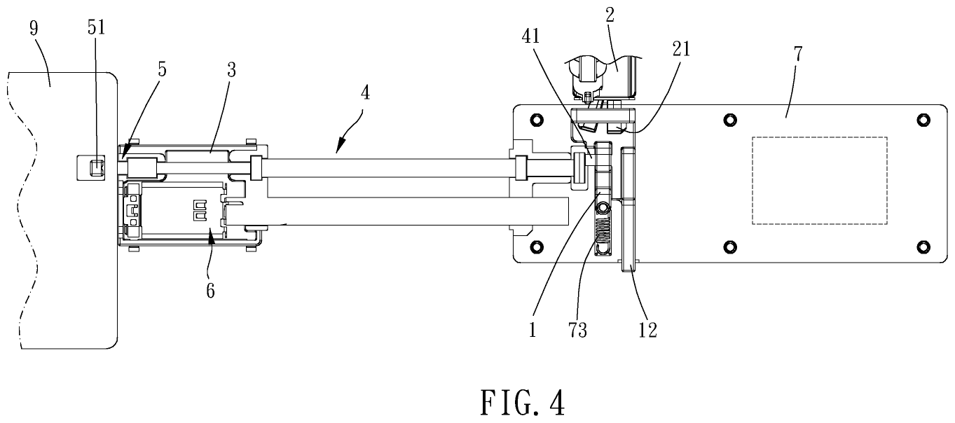

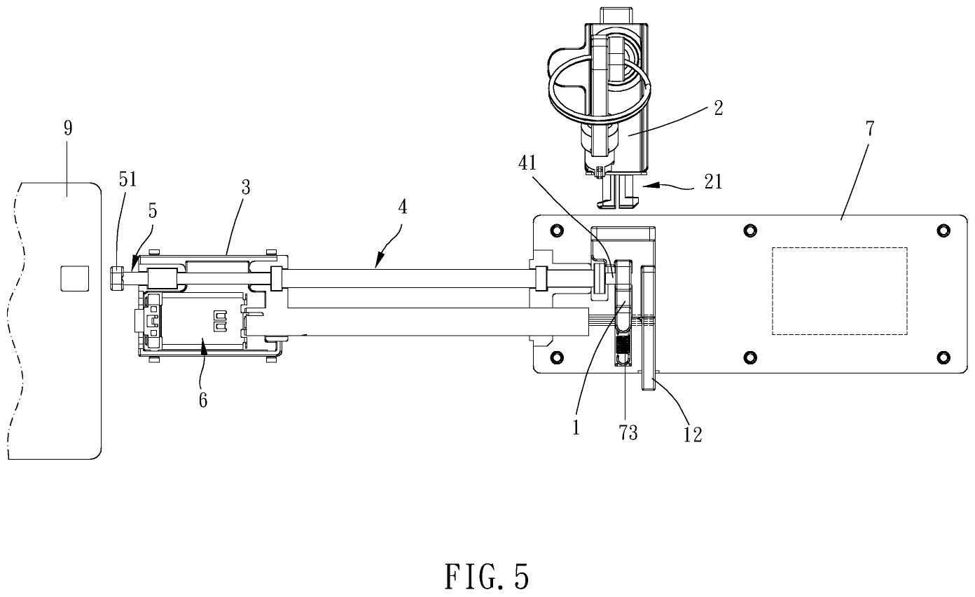

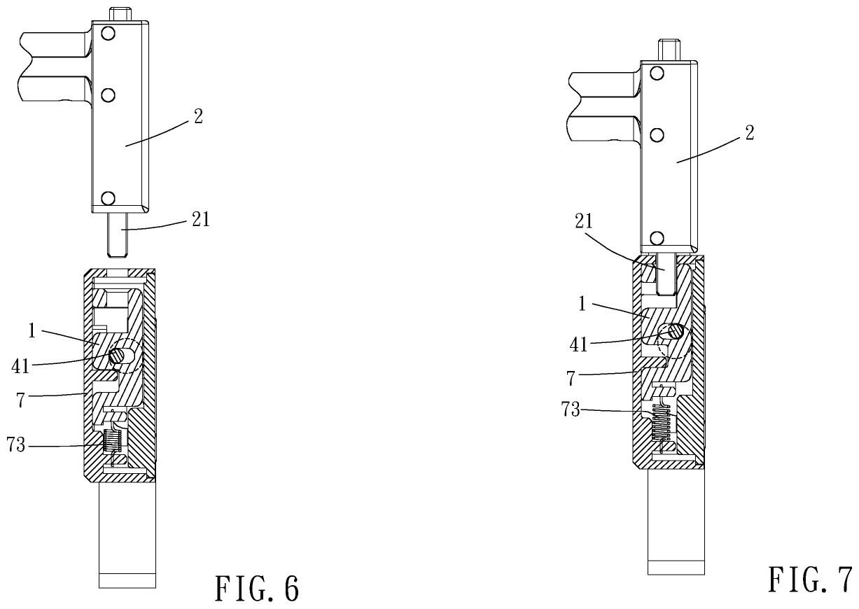

Please refer to FIGS. 1 to 7 for a preferable embodiment of the present invention. A connection lock 1 of the present invention includes a driving member 1, a locking device 2, a first housing 3, an actuating assembly 4, a blocking assembly 5 and an electronic transmission unit 6.

The driving member 1 is movable between a first position and a second position.

The locking device 2 can be restricted in the second position by the driving member 1.

The actuating assembly 4 is movably mounted to the first housing 3 and assembled with the driving member 1.

The blocking assembly 5 is mounted to the first housing 3 and movable between a release position and a blocking position, and the blocking assembly 5 is configured to be inserted within an anti-theft hole 91 of a 3C product 9 such as a notebook.

The electronic transmission unit 6 is connected to the first housing 3 and configured to be inserted within a transmission port 92 of the 3C product 9. In this embodiment, the electronic transmission unit 6 is fixedly mounted to the first housing 3 so that the electronic transmission unit 6 and the blocking assembly 5 can be inserted into or removed from the 3C product 9.

When the driving member 1 is located in the first position, the actuating assembly 4 is driven by the driving member 1 and the blocking assembly 5 is movable to be in release position, and the blocking assembly 5 is detachable from the anti-theft hole 91. When the driving member 1 is located in the second position, the driving member 1 drives the actuating assembly 4, and the actuating assembly 4 restricts the blocking assembly 5 to be positioned in the blocking position so that the blocking assembly 5 is undetachable from the anti-theft hole 91, which is burglarproof and can be integral with the electronic transmission unit 6.

Specifically, the connection lock further includes a second housing 7, and the driving member 1 and the actuating assembly 4 are movably mounted to the second housing 7. Preferably the second housing 7 includes a circuit module 71, and the electronic transmission unit 6 is electrically connected with the circuit module 71. In this embodiment, the electronic transmission unit 6 is a Type-C transmission line, the transmission port 92 is a Type-C USB (Universal Serial Bus) port, the second housing 7 further includes a plurality of adapting ports 72, and the plurality of adapting ports 72 are electrically connected with the circuit module 71, wherein the plurality of adapting ports 72 includes at least one of USB port, headphone jack and HDMI (High Definition Multimedia Interface) port. Electronic devices can be connected via the plurality of adapting ports 72, and the signals from the electronic devices can be transmitted to the 3C product 9 through the electronic transmission unit 6 and the transmission port 92, which reduces usage of many transmission lines. In this embodiment, the locking device 2 includes a locking member 21, the second housing 7 includes a locking hole 74, and the driving member 1 includes a restriction hole 11. When the driving member 1 is located in the second position, the locking member 21 can be inserted within the locking hole 74 and the restriction hole 11 at the same time and be engageable within the restriction hole 11 so that the driving member 1 cannot move to be in the first position. The locking member 21 can be driven to operate by a key, coded ring or the like.

Preferably, the connection lock further includes a first elastic member 73, an end of the first elastic member 73 is connected to the second housing 7, and another end of the first elastic member 73 is connected to one of the actuating assembly 4 and the driving member 1 so that the driving member 1 is biased toward the first position. When the locking member 21 is withdrawn from the restriction hole 11, the driving member 1 moves to be in the first position automatically so that the blocking assembly 5 is movable to be in the release position, thus being convenient to operate. In this embodiment, the driving member 1 includes a control member 12 projects out beyond the second housing 7, and the control member 12 is configured to be operated to drive the driving member 1 to be in the second position, for easy insertion of the locking member 21 into the locking hole 74 and the restriction hole 11.

In this embodiment, the actuating assembly 4 is rotatably connected to the second housing 7, and two ends of the actuating assembly 4 are respectively connected to the driving member 1 and the blocking assembly 5. When the driving member 1 is located in the first position, the driving member 1 drives the actuating assembly 4 to rotate, and the actuating assembly 4 drives the blocking assembly 5 to move to be in release position. When the driving member 1 moves to be in the second position, the driving member 1 drives the actuating assembly 4 to rotate, the actuating assembly 4 drives the blocking assembly 5 to move to be in the blocking position. Specifically, the actuating assembly 4 includes an eccentric column 41 inserted within the driving member 1, and the driving member 1 is slidably connected to the second housing 7 and slidable in a direction lateral to an axis about which the actuating assembly 4 rotates. The blocking assembly 5 and the actuating assembly 4 are rotatably mounted to the first housing 3 and movable with each other. The blocking assembly 5 includes a blocking member 51 having a shape corresponding to a shape of the anti-theft hole 91. When the blocking assembly 5 is located in the release position, the blocking member 51 is penetrable through the anti-theft hole 91. When the blocking assembly 5 is rotated to be in the blocking position, the blocking member 51 is blocked within the anti-theft hole 91.

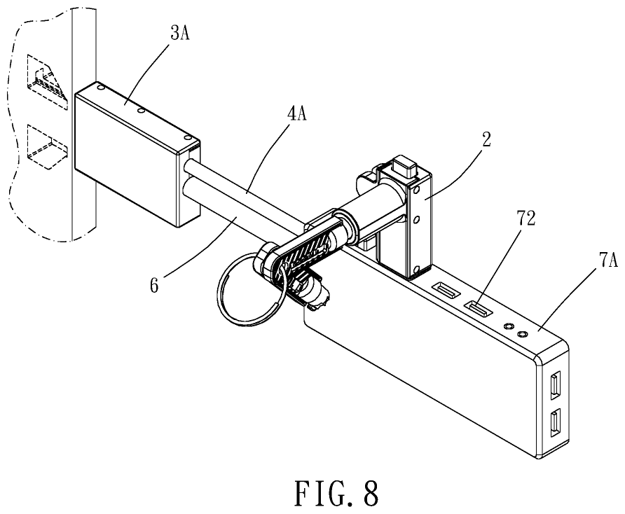

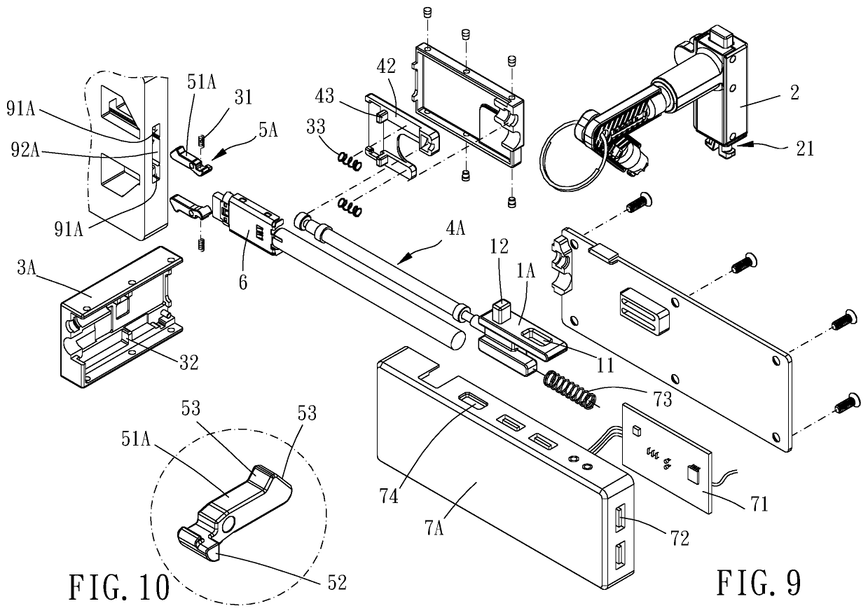

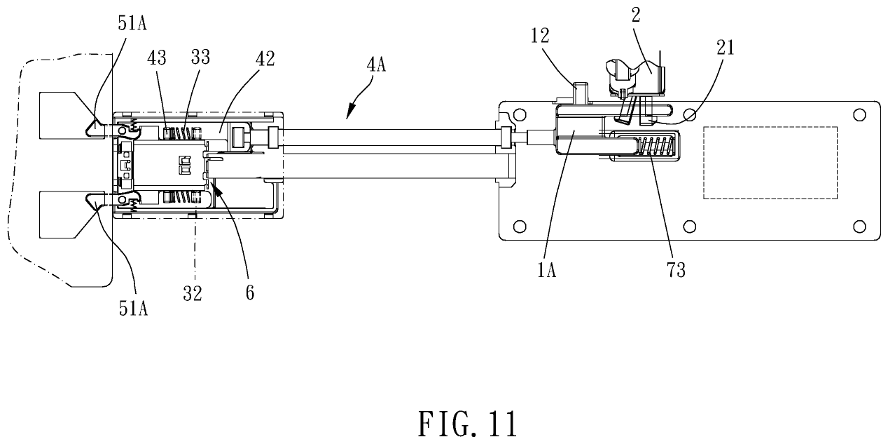

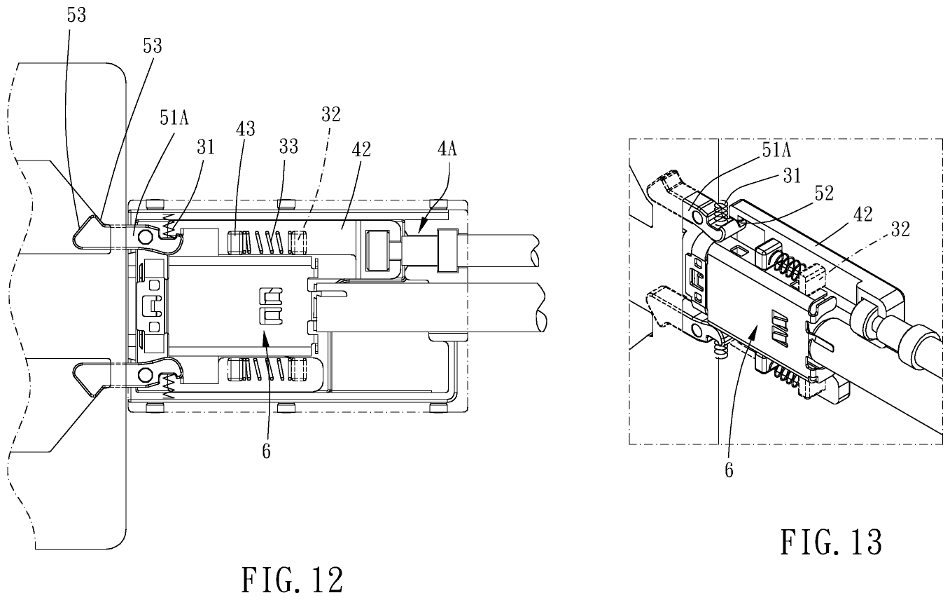

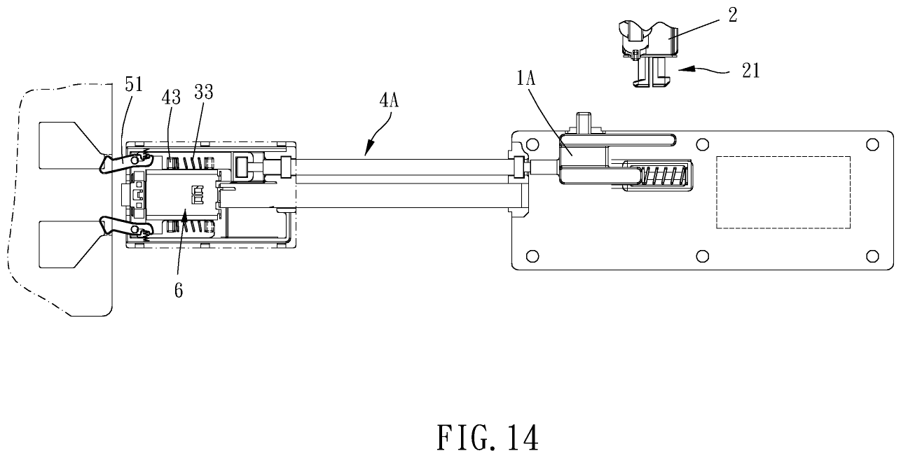

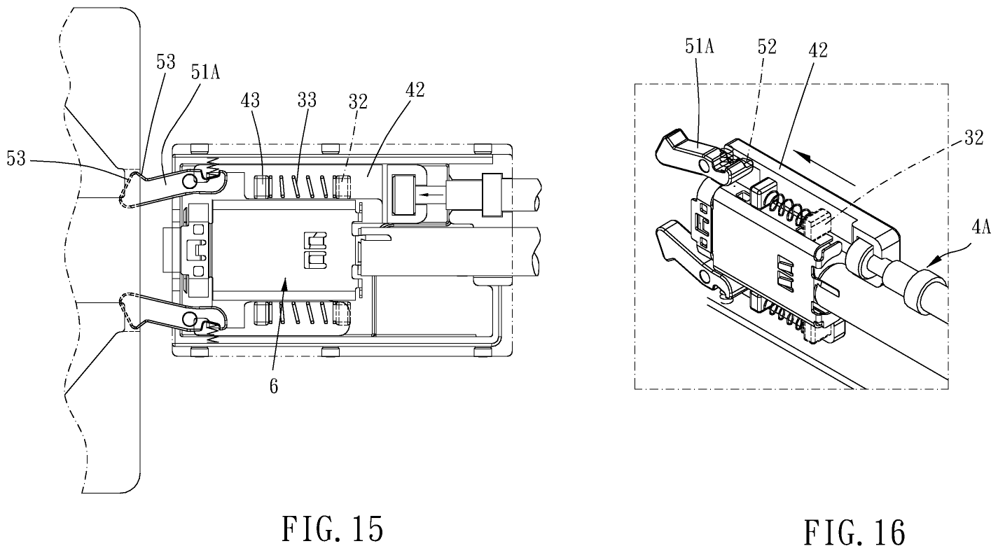

As shown in FIGS. 8-16 for another embodiment, the driving member 1A is slidably mounted to the second housing 7A, the actuating assembly 4A is slidably disposed between the first housing 3A and the second housing 7A, and the actuating assembly 4A and the driving member 1A are connected with each other.

Specifically, the blocking assembly 5A includes two blocking members 51A swingably mounted to the first housing 3A. When the blocking assembly 5A is located in the release position, the two blocking members 51A approach to each other and are penetrable through the anti-theft hole 91A. When the blocking assembly 5A is located in the blocking position, the two blocking members 51A swing away from each other and are blocked within the anti-theft hole 91A. In this embodiment, the transmission port 92A is located in the anti-theft hole 91A, and the electronic transmission unit 6 is disposed between the two blocking members 51A.

In this embodiment, each said blocking member 51A includes a projection 52, and the actuating assembly 4A includes a restricting member 42. When the driving member 1A is located in the first position, the restricting member 42 does not abut against each said projection 52, and the two blocking members 51A are freely swingable. Preferably, each of the two blocking members 51A includes two inclined faces 53 which are angularly connected and configured to be inserted within the anti-theft hole 91A. The two inclined faces 53 of each said blocking member 51A can make each said blocking member 51A be smoothly inserted into or withdrawn from the anti-theft hole 91A. When the driving member 1A moves from the first position toward the second position, the driving member 1A drives the actuating assembly 4A and the restricting member 42 to move, the restricting member 42 is abutted against and blocked by each said projection 52 so that the two blocking members 51A swing away from each other and are not penetrable through the anti-theft hole 91A.

Preferably, a second elastic member 31 is disposed between the first housing 3A and respective one of the two blocking members 51A, and each said second elastic member 31 biases the respective one of the two blocking members 51A so that the two blocking members 51A swing away from each other. The first housing 3A includes at least one first blocking portion 32, the restricting member 42 includes at least one second blocking portion 43, between each of the at least one first blocking portion 32 and one of the at least one second blocking portion 43 is a third elastic member 33 so that the restricting member 42 is biased in a direction away from the second housing 7A and so that the restricting member 42 is normally not abutted against each said projection 52.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A connection lock, including:
a driving member, movable between a first position and a second position;
a locking device by which the driving member is restrictable in the second position;
a first housing;
an actuating assembly, movably mounted to the first housing and assembled with the driving member;
a blocking assembly, mounted to the first housing and movable between a release position and a blocking position, configured to be inserted within an anti-theft hole of a 3C product;
an electronic transmission unit, connected to the first housing, configured to be inserted within a transmission port of the 3C product;
wherein when the driving member is located in the first position, the actuating assembly is driven by the driving member and the blocking assembly is movable to be in the release position, and the blocking assembly is detachable from the anti-theft hole; when the driving member is located in the second position, the driving member drives the actuating assembly, and the actuating assembly restricts the blocking assembly to be positioned in the blocking position so that the blocking assembly is undetachable from the anti-theft hole.

2. The connection lock of claim 1, further including a second housing, wherein the driving member and the actuating assembly are movably mounted to the second housing.

3. The connection lock of claim 2, wherein the second housing includes a circuit module, the electronic transmission unit is electrically connected with the circuit module, the second housing further includes a plurality of adapting ports, and the plurality of adapting ports are electrically connected with the circuit module.

4. The connection lock of claim 3, wherein the plurality of adapting ports includes at least one of USB port, headphone jack and HDMI port.

5. The connection lock of claim 2, further includes a first elastic member, wherein an end of the first elastic member is connected to the second housing, and another end of the first elastic member is connected to one of the actuating assembly and the driving member so that the driving member is biased toward the first position.

6. The connection lock of claim 5, wherein the locking device includes a locking member, the second housing includes a locking hole, the driving member includes a restriction hole, when the driving member is located in the second position, the locking member can be inserted within the locking hole and the restriction hole at the same time and be engageable within the restriction hole so that the driving member cannot move to be in the first position.

7. The connection lock of claim 5, wherein the driving member includes a control member projects out beyond the second housing, and the control member is configured to be operated to drive the driving member to be in the second position.

8. The connection lock of claim 1, wherein the electronic transmission unit is fixedly mounted to the first housing.

9. The connection lock of claim 2, wherein the actuating assembly includes an eccentric column inserted within the driving member, the driving member is slidably connected to the second housing and slidable in a direction lateral to an axis about which the actuating assembly rotates, the blocking assembly and the actuating assembly are rotatably mounted to the first housing and movable with each other, the blocking assembly includes a blocking member having a shape corresponding to a shape of the anti-theft hole, when the blocking assembly is located in the release position, the blocking member is penetrable through the anti-theft hole; and when the blocking assembly is rotated to be in the blocking position, the blocking member is blocked within the anti-theft hole.

10. The connection lock of claim 1, wherein the blocking assembly includes two blocking members swingably mounted to the first housing, when the blocking assembly is located in the release position, the two blocking members approach to each other and are penetrable through the anti-theft hole; and when the blocking assembly is located in the blocking position, the two blocking members swing away from each other and are blocked within the anti-theft hole.

11. The connection lock of claim 10, wherein each said blocking member includes a projection, the actuating assembly includes a restricting member, when the driving member is located in the first position, the restricting member does not abut against each said projection, the two blocking members are freely swingable; when the driving member moves from the first position toward the second position, the driving member drives the actuating assembly and the restricting member to move, the restricting member is abutted against and blocked by each said projection so that the two blocking members swing away from each other.

12. The connection lock of claim 11, wherein each of the two blocking members includes two inclined faces which are angularly connected and configured to be inserted within the anti-theft hole.

13. The connection lock of claim 12, wherein a second elastic member is disposed between the first housing and respective one of the two blocking members, and each said second elastic member biases the respective one of the two blocking members so that the two blocking members swing away from each other.

14. The connection lock of claim 11, wherein further includes a second housing, the driving member and the actuating assembly are movably mounted to the second housing, the first housing includes at least one first blocking portion, the restricting member includes at least one second blocking portion, between each of the at least one first blocking portion and one of the at least one second blocking portion is a third elastic member so that the restricting member is biased in a direction away from the second housing.

15. The connection lock of claim 2, wherein the actuating assembly is rotatably connected to the second housing, and two ends of the actuating assembly are respectively connected to the driving member and the blocking assembly.

16. The connection lock of claim 15, wherein when the driving member is located in the first position, the driving member drives the actuating assembly to rotate, and the actuating assembly drives the blocking assembly to move to be in the release position; and when the driving member moves to be in the second position, the driving member drives the actuating assembly to rotate, and the actuating assembly drives the blocking assembly to move to be in the blocking position.

17. The connection lock of claim 2, wherein the driving member is slidably mounted to the second housing, the actuating assembly is slidably mounted between the first housing and the second housing, and the actuating assembly and the driving member are connected with each other.
